(19) United States
(12) Patent Application Publication
(10) Pub. No.: US 2021/0008458 A1
(43) Pub. Date: Jan. 14, 2021

(54) FANTASY SPORTS APP

(71) Applicant: SUPERDRAFT, INC., Windham, NH (US)

(72) Inventors: Steven Wang, Windham, NH (US); Nathaniel Lasee, Manchester, NH (US)

(21) Appl. No.: 16/926,181

(22) Filed: Jul. 10, 2020

Related U.S. Application Data
(60) Provisional application No. 62/873,662, filed on Jul. 12, 2019.

(51) Int. Cl. A63F 13/828; A63F 13/46; A63F 13/58; A63F 13/65

(52) U.S. Cl. CPC A63F 13/828; A63F 13/46; A63F 13/58; A63F 2300/65; A63F 2300/8052; A63F 2300/69; A63F 2300/61; A63F 13/65

(57) ABSTRACT

Aspects of the disclosure include a method of providing a fantasy sports application, the method comprising acts of determining, for a first athlete, a first modifier based on an expected performance of the first athlete, determining, for the first athlete, a raw score value based on a performance of the first athlete in a sporting event, determining, for the first athlete, a modified score value based on the first modifier and based on the raw score value, and awarding the modified score value to at least one user of the fantasy sports application.

### CROSS-REFERENCE TO RELATED APPLICATION

This application claims priority under 35 U.S.C. § 119(e) to U.S. Provisional Application Ser. No. 62/873,662, titled “FANTASY SPORTS APP,” filed on Jul. 12, 2019, which is hereby incorporated by reference in its entirety.

### BACKGROUND

### 1. Field of the Disclosure

At least one example in accordance with the present disclosure relates generally to fantasy sports applications.

### 2. Discussion of Related Art

The use of electronic devices, such as mobile telephones, to execute user applications is known. Certain conventional user applications provide a platform for users to engage in fantasy sports. For example, certain conventional fantasy sports applications allow users to “draft” athletes, and award points to users based on the drafted athletes' real-life performance. Users are typically members of leagues, or groups, of other users competing to obtain the most points in a given period of time, such as a length of a baseball season.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of fantasy sports application features according to an embodiment;

FIG. 2 illustrates a view of an athlete selection screen according to an embodiment;

FIG. 3 illustrates a process of utilizing a points multiplier according to an embodiment;

FIG. 4 illustrates a process of determining a points multiplier according to an embodiment;

FIG. 5 illustrates a process of earning rewards according to an embodiment;

FIG. 6 illustrates a view of a daily spinner wheel game according to an embodiment;

FIG. 7 illustrates a view of an example rewards screen according to an embodiment;

FIG. 8 illustrates a view of a rivalry feature according to an embodiment;

FIG. 9 illustrates a process of executing squad-based competitions according to an embodiment;

FIG. 10 illustrates a process of executing a prediction feature; and

FIG. 11 illustrates a view of prediction feature according to an embodiment;

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are no intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

As discussed above, conventional fantasy sports applications may invite users to “draft” sports athletes to be on the users' respective fantasy teams. While the athlete is on a user's fantasy team, points will be awarded to the user based on the athlete's real-life performance. For example, in the context of basketball, a user may draft a basketball athlete before the athlete competes in a basketball game. The user may be awarded points by the fantasy sports application based on the athlete's performance in the basketball game.

Some conventional fantasy sports applications impose a maximum salary cap on users for drafting players. Each athlete capable of being drafted is associated with a drafting fee which is deducted from the user's available salary. Typically, an athlete's drafting fee is positively correlated with the athlete's expected performance. For example, in the context of American football, a quarterback that is expected to perform very well may be associated with a higher drafting fee than a quarterback that is expected to perform very poorly. Thus, in drafting athletes to form fantasy sports teams in conventional applications, maximum salary caps generally prevent users from selecting only the highest-performing athletes associated with the highest drafting fees. Furthermore, because a user has a single pool of funds to draft the user's entire team, each athlete selection impacts the user's ability to select other athletes by diminishing the single pool of funds.

Embodiments of the present disclosure are related to a fantasy sports application. The application may be executed by an electronic device including, for example, a mobile phone, a tablet device, a personal computing device, and so forth. In one embodiment, the fantasy sports application associates athletes with points multipliers. Athletes obtain a raw score value based on the athletes' real-life performance. The raw score is modified by the points multiplier to produce a modified score, which is awarded to the user that drafted the athletes.

Generally speaking, a low-performing athlete is associated with a high points multiplier. Conversely, a high-performing athlete is associated with a low points multiplier. As the athlete scores points, the points are multiplied by the athlete's points multiplier to produce a modified points value. Thus, a low-performing athlete may nonetheless provide more modified points than a high-performing athlete after the athletes' respective points multipliers are taken into account. According to aspects and embodiments, users are not restricted by a salary cap in selecting players. Rather, users evaluate the risk and reward that multipliers impose in selecting athletes to draft. Furthermore, each athlete selection is independent of other athlete selections inasmuch as selecting an athlete does not diminish a pool of funds or otherwise restrict the user's ability to select another athlete.

Accordingly, as compared to conventional salary cap-based games in which users may simply draft athletes having a maximum expected-points-per dollar ratio, a points multiplier-based model enables users to select athletes according to which athletes are expected to have the best statistical performance in conjunction with a corresponding multiplier. Because each athlete selection is independent of other selections in a points multiplier-based model, users may pick athletes based primarily on the athletes' expected individual value, rather than the impact that the selection will have on drafting remaining athletes for the team. Thus, one aspect of assigning a multiplier to each individual athlete is that it allows the player to draft a team without the restrictions of a Salary Cap. Another aspect of assigning a multiplier to each individual athlete is that it changes the way that you draft your team. Without the restriction of drafting a team to fit within a salary cap, players will be challenged with drafting a team of the best performing athletes (relative to their multipliers) for a given contest rather than one which fits best within the restrictions of Salary Cap.

Many new strategies will develop for drafting a team that don't exist within the Salary Cap game framework. By way of example, rather than finding the “best bang for your buck” with Salary Cap (Athlete X has expected value of 2.4 points per $100 vs. Athlete Y who has expected value of 3.2 points per $100), players of the game will be looking for athletes that they believe will have the best statistical performances in conjunction with their multiplier value. Thus, every pick of an athlete made by a player is an individual decision that doesn't impact other choices. An athlete's value is based off of his overall expected value in relation to his multiplier and a fantasy sports player can use his or her knowledge to build the best roster they can, which provides for fantasy sports players to use more knowledge and intuition. One advantage of using a multiplier for each athlete and for drafting an entire team based on multipliers (with no salary cap), is that can be more fun, more challenging, and/or more rewarding for the fantasy sports player.

It is also appreciated that according to aspects and embodiments, the multiplier feature can be used in combination with a Salary Cap to draft a team or squad for a contest. For example, a salary cap $80,000 (of by way of example only) may be given to each player to draft a team and each player may be assigned a salary and a multiplier value, and a player will have to use a combination of the multiplier value and the player's salary to draft a team that does not exceed the overall Salary Cap.

As will be discussed herein, additional features may also be provided including, for example, a rewards feature, a rivalry feature, a squads feature, a user prediction feature, and a ranking feature. Embodiments of the fantasy sports application may include some or all of the foregoing features.

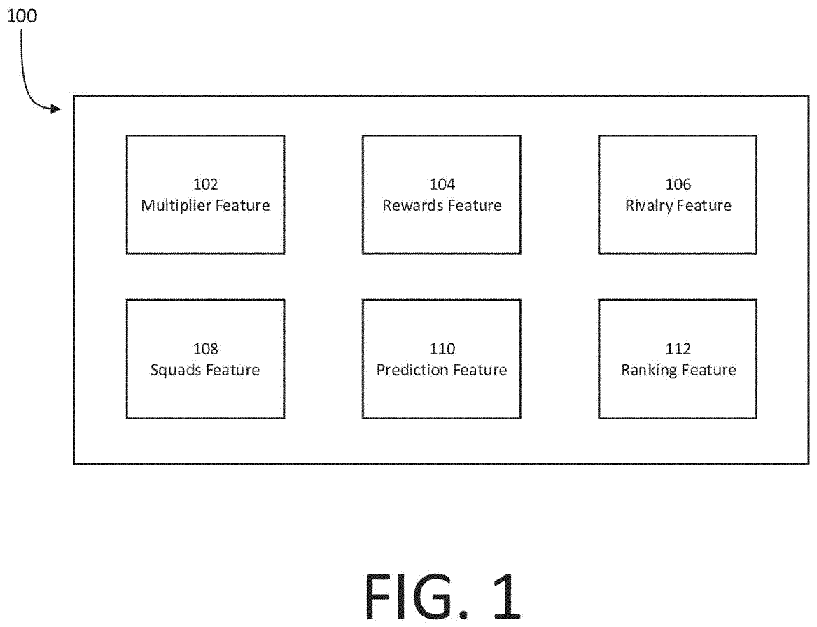

FIG. 1 illustrates a block diagram of features 100 that may be provided by a fantasy sports application executed by an electronic device. The features 100 include a multiplier feature 102, a rewards feature 104, a rivalry feature 106, a squads feature 108, a prediction feature 110, and a ranking feature 112. Any one of all of the features 100 may be implemented in any combination in embodiments of the disclosure.

The multiplier feature 102, as discussed in greater detail below, associates athletes with multipliers that are multiplied by the athletes' raw scores to produce modified points values. Thus, in deciding whether to draft an athlete, a user may weigh the athlete's expected performance against the athlete's points multiplier value, rather than weighing the athlete's expected performance against a drafting fee for the athlete.

The rewards feature 104, as discussed in greater detail below, provides users with rewards in response to various conditions. Rewards may include rewards points, for example, which may be exchanged for prizes. For example, rewards points may be obtained by redeeming daily rewards, or participating in challenges.

The rivalry feature 106, as discussed in greater detail below, provides users with information about the users' rivals. For example, a first user's rivals may be other users that the first user has competed against most often. Rival information may include win-loss records against each respective rival, winning or losing streaks against each respective rival, and so forth.

The squads feature 108, as discussed in greater detail below, enables users to form “squads,” or groups of other users. Squads may compete against other squads. For example, in a competition between a first squad and a second squad, each squad's users' points may be aggregated to determine an aggregate squad score. A squad having a highest aggregate squad score may win the competition.

The prediction feature 110, as discussed in greater detail below, enables users to predict an outcome of an event before the event occurs in real-time. For example, in an American football event, a user may predict an outcome of a team's drive (for example, a passing touchdown, a rushing touchdown, a turnover, and so forth). Users are rewarded for correctly predicting an outcome of an event. Rewards may be correlated to the complexity or specificity of the prediction such that harder-to-predict events are better-compensated than easier-to-predict events.

The ranking feature 112, as discussed in greater detail below, provides users with rankings based on their performance. Rankings may be specific to different sporting events. For example, a user may have a basketball ranking and a baseball ranking, each of which is independent of the other. Users may advance in each sport's rankings by participating in events associated with the respective sport, such as by winning a squad-based competition associated with the sport.

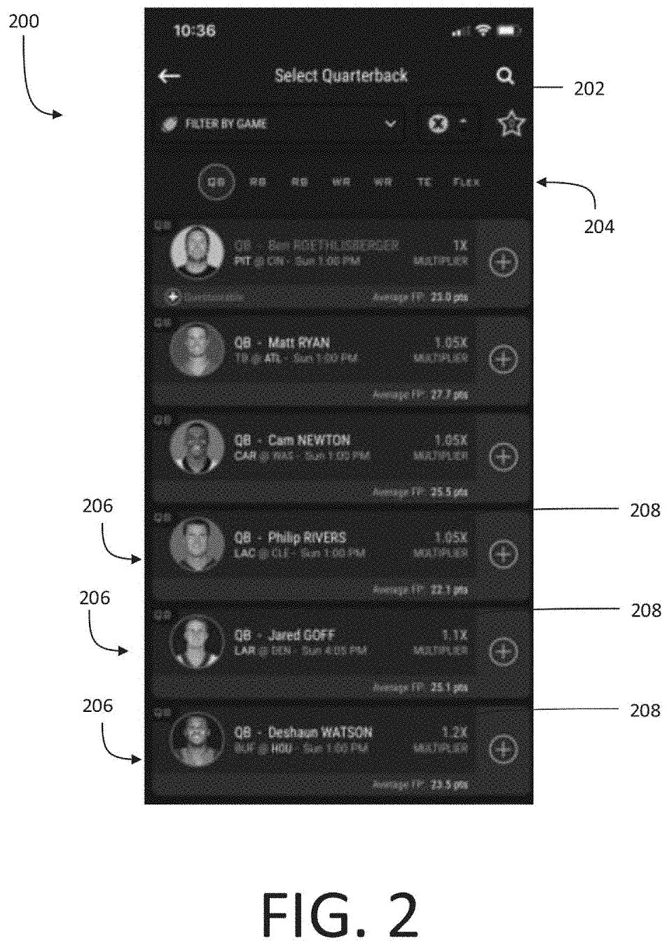

The multiplier feature 102 will now be discussed in greater detail. FIG. 2 illustrates a view 200 of an athlete selection screen. The view 200 includes a game filtering selection 202, a position selection 204, and player profiles 206. Each of the player profiles 206 includes a respective points multiplier 208, which may alternately be referred to herein as points modifiers.

The athlete selection screen enables users to select an athlete to draft. Users draft athletes until a full fantasy team is selected. For example, a full fantasy American football team may include a quarterback, two running backs, two wide receivers, a tight end, and a flex athlete (for example, any one of a receiver, tight end, or running back). It is appreciated that a team can include more or less players and that the illustrated composition of a team is one example. After drafting a full team, the user receives points based on the drafted athletes' performances. The points received by the user may also be modified by the points multipliers 208 associated with the drafted athletes, as discussed below.

The game filtering selection 202 selects a sporting event. The view 200 illustrates American football as a selected sporting event. Other sporting events may include, for example, golf, basketball, hockey, soccer, baseball, or other sporting events which may be selected via the game filtering selection 202.

The position selection 204 selects a position associated with the selected sporting event. As discussed above, the view 200 is associated with American football. Thus, the position selection 204 includes American football positions including a quarterback, running backs, wide receivers, a tight end, and a flex position. In the view 200, the quarterback position has been selected in the position selection 204. Alternate positions may be associated with alternate sporting events. For example, responsive to a user selecting hockey in the game filtering selection 202, the position selection 204 may include positions such as center, forward, goalkeeper, and so forth.

The player profiles 206 provide information about athletes who may be drafted. The athletes are associated with the sporting event selected in the game filtering selection 202, and play in the position selected in the position selection 204. Thus, in the view 200, the player profiles 206 are associated with American football quarterbacks. For example, the player profiles 206 may provide information including the athlete's name, average fantasy points, upcoming game information, a player selection button, and points multipliers 208.

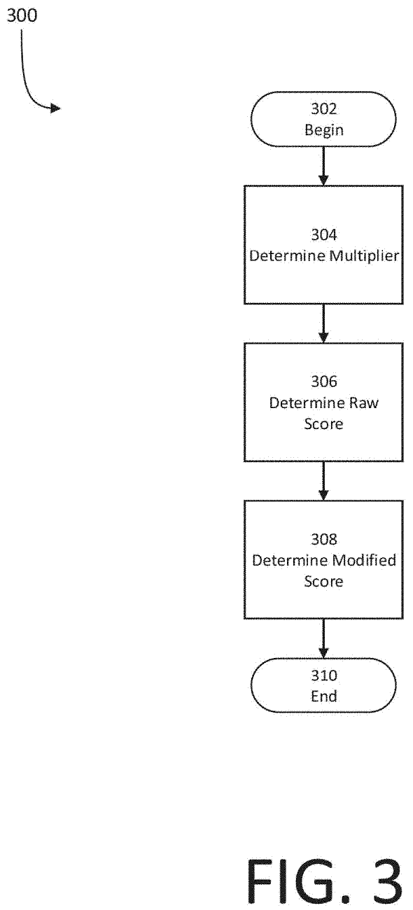

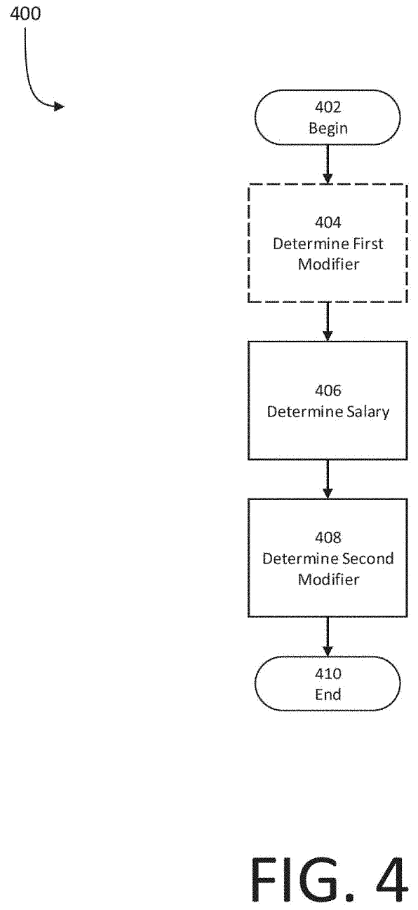

As discussed above, the points multipliers 208 may modify a raw score obtained by athletes. Based on the player profiles 206, a user may select athletes to draft until the user's team is completed. After the team has been drafted and the game or event has occurred, the drafted athletes obtain a raw score value, which is multiplied by a respective multiplier of the points multipliers 208. The user then receives points based on the drafted athletes' performances in the game or event and based on the points multipliers 208 associated with the drafted athletes. An example implementation of one process of determining overall points or an overall score using the points multipliers 208 is discussed with respect to FIG. 3, below. An example process of determining the points multipliers 208 is discussed with respect to FIG. 4, below.

FIG. 3 illustrates a process 300 of utilizing a points multiplier 208 in connection with an determining total points accrued by an athlete. The process 300 may be executed by examples of the fantasy sports application. At act 302, the process 300 begins. At act 304, a respective points multiplier, or modifier, is determined for each athlete. Determining the points multiplier is based on an athlete's historical and expected performance, as discussed in greater detail below with respect to FIG. 4. Generally speaking, lower points multipliers (for example, 1.05) are associated with athletes expected to perform well and thus obtain a higher raw score, and higher points multipliers (for example, 1.25) are associated with athletes expected to perform poorly and thus obtain a lower raw score.

At act 306, each athlete's raw score is determined. An athlete's raw score may be based on the athlete's performance in a game. Fixed score values may be associated with specific in-game actions based on the athlete's position. Table 1 illustrates an example of points values that may be granted for corresponding conditions satisfied by a pitcher in a baseball game.

TABLE 1
Example of Pitcher Points Values

| Scoring Condition | Points Granted | |
|---|---|---|
| Pitching in Inning (3 outs) | 2 | points |
| Strike Out | 2 | points |
| Winning Game | 4 | points |
| Inducing a ground into | 0.5 | points |
| Double Play | | |
| Allowing an Earned Run | −2 | points |
| Hit Allowed | −0.5 | points |
| Walk Issued | −0.5 | points |
| Hit Batter | −0.5 | points |

Similar principles apply to other sporting events, whereby users' drafted athletes score, or lose, points by meeting specified conditions in a game. Once the game is completed, a raw score is calculated for each athlete as an aggregation of the points earned or lost during the game based on achieving such conditions. For example, and continuing with the example provided in connection with Table 1, a pitcher may play for a single inning, strike out three hitters, and consequently win the game. The pitcher receives two points for pitching in an inning, two points for each strike-out for a total of six points, and four points for winning the game. The points earned for each individual event are aggregated to generate a final raw score of 12 points.

At act 308, a modified score is determined for each athlete. In one example, an athlete's modified score is the product of the athlete's points multiplier determined at act 304, which is determined before a game, and the athlete's raw score determined at act 306, which is determined during a game. Continuing with the example of the pitcher above, the pitcher's raw score of 12 points is multiplied by the pitcher's points multiplier as determined at act 304.

For example, the pitcher may have been expected to perform poorly in the game based on the pitcher's historical performance. The pitcher may have thus been associated with a high multiplier, such as a multiplier of 2.0. In this example, the pitcher's modified score is 24 points, or the product of 12 points and the multiplier of 2.0. Thus, users who drafted the pitcher receive 24 points from the pitcher, rather than the raw score of 12 points. At act 310, the process 300 ends.

Examples of act 304 will now be discussed with respect to FIG. 4. FIG. 4 illustrates a process 400 of determining a points multiplier 208 for an athlete. The process 400 may be executed to determine a points multiplier based on a sport played by the athlete, and based on a position played by the athlete. For example, embodiments of the process 400 to determine a points multiplier of a baseball pitcher may differ from embodiments of the process 400 to determine a points multiplier for a baseball hitter, as discussed in greater detail below. Examples of the process 400 include a determination of a points multiplier for a baseball pitcher for purposes of explanation only.

At act 402, the process 400 begins. At optional act 404, a first modifier is determined for an athlete. The first modifier may be determined based on an expected performance of a team against which the athlete is scheduled to play. For example, the first modifier may reflect a number of points that the athlete is expected to score relative to a number of points that the athlete normally scores. Thus, if the athlete is expected to play against a better-than-average team, the first modifier may be 90%, indicating that the athlete is expected to score 10% fewer points than the athlete scores on average due to the higher skill of the opposing team.

In some embodiments, optional act 404 may only be executed where the athlete's performance is contingent upon an opposing team or player. For example, in an American football game, a quarterback's performance is contingent, in part, on the performance of an opposing team's defensive players. Conversely, although golf is a competitive sport, one golfer's performance may not be directly affected by the other's golfer's performance.

In an example in which the athlete is a pitcher, the first modifier may reflect an expected performance of an opposing team's hitters. Generally speaking, if the opposing team's hitters are better than average hitters in a league in which the hitters play, then the first modifier may be less than 100% because the pitcher is expected to score fewer points than normal. If the opposing team's hitters are worse than average hitters in the league in which the hitters play, then the first modifier may be greater than 100% because the pitcher is expected to score more points than normal.

As discussed above, the first modifier may be determined based on an expected performance of an opposing team against which the athlete is scheduled to play. For example, the first modifier may be determined based on a historical performance of the opposing team. In one example, the first modifier may be determined by Equation (1),

$$M = \frac{( I * 2 ) + ( S * 2 ) + ( L * 4 ) - ( R * 2 ) - ( \frac{H + W + P}{2} )}{G * A}$$

where M is the first modifier, I is a number of regular innings played by the opposing team in a period of time (for example, a current season), S is a number of strike outs by the opposing team's hitters in the period of time, L is a number of team losses by the opposing team in the period of time, R is a number of runs by the opposing team's hitters in the period of time, H is a number of hits by the opposing team's hitters in the period of time, W is a number of walks by the opposing team's hitters in the period of time, P is a number of hits by pitch (HBP) of the opposing team's hitters in the period of time, G is a number of games played by the opposing team in the period of time, and A is an average score of pitchers in a league in which the opposing teams play across the period of time.

For example, the pitcher may be scheduled to play against a team that has played 53 games in a current season, has 398 strikeouts in the current season, has 25 losses in the current season, has 249 runs in the current season, has 460 hits in the current season, has 177 walks in the current season, and has 21 HBPs in the current season, in a league in which the average hitter score is 22.34. Applying Equation (1), the pitcher will have a first modifier of approximately 0.86, indicating that the pitcher, in playing against the team, is expected to score approximately 86% of the points that the pitcher would normally score on average.

In some embodiments, the first modifier M may be limited within a range. For modifiers above the range, the modifiers may be automatically limited to the upper limit of the range. For modifiers below the range, the modifiers may be automatically limited to the lower limit of the range. For example, the first modifier M may be limited between 0.9 and1.1. Thus, if Equation (1) yields a first modifier M that is greater than 1.1, then the first modifier M may be set to 1.1. If Equation (1) yields a first modifier M that is less than 0.9, then the first modifier M may be set to 0.9. Accordingly, in the example above, the team's first modifier M of 0.86 may be automatically limited to 0.9.

At act 406, a base salary is determined for the athlete. The base salary may be determined based on the athlete's historical performance and, in some embodiments, based on the athlete's expected future performance. The expected future performance may be determined based on the skill of a team against which the athlete is scheduled to play, and may be used to determine the base salary only where act 404 is executed. The historical performance may be based on the athlete's performance in games previously played by the athlete. For example, the base salary may be determined based on the athlete's historical average score in a group of games played by the athlete, and based on the first modifier determined at act 404. In one example, the base salary may be determined by Equation (2),

B=V*M*D

where B is the athlete's base salary, V is the athlete's average score across a group of one or more games, M is a modifier indicating an expected performance of a team against which the athlete is scheduled to play (for example, the first modifier calculated at act 404), and D is a dollar value. For example, the dollar value D may be $800. In some examples, the athlete's base salary B may be rounded to a nearest multiple of a dollar value, such as $10, $100, $1,000, and so forth.

In one example, the athlete's average score V may include only the athlete's best performances in the group of one or more games. For example, the athlete's average score V may be determined across m of the athlete's n most recent games, where m is equal to or less than n. For example, the athlete's average score V may be determined using the athlete's five highest scores in the athlete's six most recent games in one example.

Continuing with the foregoing example of the pitcher discussed above with respect to act 404, the modifier M may be 0.9, the pitcher's five best scores in the pitcher's six most recent games may be 26, 16.33, 19.5, 15, and 28, yielding an average score V of approximately 20.966, and the base salary B may be rounded to a nearest multiple of $100. Applying Equation (2), the pitcher's base salary B is $15,100.

At act 408, a second modifier is determined for the athlete. The second modifier may represent an athlete's points multiplier of the points multipliers 208. The second modifier may be determined based on the athlete's base salary, and based on a salary of a highest-earning player playing in the same or a similar position as the athlete in the league in which the athlete plays. For example, the second modifier may be determined by Equation (3),

O=E/B

where O is the second modifier for the athlete, E is the salary of the highest-earning player playing in the same or a similar position as the athlete, and B is the athlete's base salary (for example, the base salary B determined above with respect to Equation [2]). In some examples, the athlete's second modifier O may be rounded to a nearest multiple of a value, such as 0.01, 0.05, 0.1, and so forth.

Continuing with the example above, in which the pitcher has a base salary B of $15,100, the highest-earning pitcher in the league in which the pitchers play may be $25,000 and the second modifier O may be rounded to a nearest multiple of 0.05. Applying Equation (3), the second modifier O for the pitcher is approximately 1.66, which is rounded to a final second modifier value O of approximately 1.65.

In some embodiments, the second modifier O may be limited within a range. For modifiers above the range, the modifiers may be automatically limited to the upper limit of the range. For modifiers below the range, the modifiers may be automatically limited to the lower limit of the range. For example, the second modifier O may be limited between 1.0 and 2.0. Thus, if Equation (3) yields a second modifier O that is greater than 2.0, then the second modifier may be set to 2.0. Accordingly, in the example above, the athlete's second modifier O of 1.65 is not altered because it is within the range of 1.0 to 2.0. At act 410, the process 400 ends.

As indicated above, in Equation (3), the pitcher's base salary B may only be compared to the salary of another pitcher (as opposed to, for example, a salary of a hitter). In other sporting events, a first player's base salary may be compared to a salary of a second player who plays in a similar but different position than the first player.

For example, in American football, a second modifier O may be determined for a wide receiver. In calculating the second modifier O, the wide receiver's salary may be compared to a highest salary from a pool of players including wide receivers and tight ends. The wide receiver position may be considered to be similar to the tight end position at least because each of the foregoing positions is an offensive scoring position relying on passing to gain yards (as opposed to, for example, running backs). Conversely, pitchers and hitters may not be considered to be similar positions, because the positions have fundamentally different objectives and roles.

In other examples, the highest-earning player's salary may be determined across a larger or smaller pool of players. For example, in calculating a second modifier O for an athlete, E may be determined only for the highest-earning player playing in the same position as the athlete. In another example, in calculating the second modifier O for the athlete, E may be determined for the highest-earning player playing in the same sporting event as the athlete, regardless of position. In other examples, any other pool of players may be analyzed for the purpose of determining a salary of a highest-earning player.

As discussed above, in some examples, the process 400 may be executed without executing the act 404. For example, act 404 may not be executed where the athlete for whom the process 400 is executed is not competing in a sport in which the athlete's performance is directly contingent on an opposing team or player's performance. The athlete's performance may include acts performed by the athlete during a game, as distinguished from the points awarded to the athlete in embodiments of the fantasy sports application (for example, the points awarded according to Table 1, above, or Table 2, below). Act 404 may therefore not be executed for a golfer, for example, because the golfer's performance is not directly affected by an opposing golfer's performance, although the points awarded to the golfer may vary based on the opposing golfer's performance (for example, where points are awarded based on a place in which the golfers finish).

In one example, executing the process 400 for an athlete without executing optional act 404 includes determining, at act 406, a base salary for the athlete. For example, the athlete's base salary may be determined by Equation (4),

B=V*D

where B is the athlete's base salary, V is the athlete's average score across a group of one or more games, and D is a dollar value (for example, $200). In one example, the athlete's average score V may include only the athlete's best performances in the group of one or more games. The athlete's average score V may be determined across m of the athlete's n most recent games, where m is equal to or less than n. For example, the athlete's average score V may be determined across five of the athlete's six most recent games in one example. In some examples, the athlete's base salary B may be rounded to a nearest multiple of a dollar value, such as $10, $100, $1,000, and so forth.

For example, in an embodiment in which the athlete is a golfer, the athlete may score points according to the conditions indicated in Table 2.

TABLE 2
Example of Golfer Points Values

| Scoring Condition | Points Granted | |
|---|---|---|
| Double Eagle | 8 | points |
| Eagle | 4 | points |
| Birdie | 2 | points |
| Par | 1 | point |
| Bogey | −1 | point |
| Double Bogey | −2 | points |
| Triple Bogey or Worse | −3 | points |
| Sand Save | 1 | point |
| 25+ ft. Putt Made | 3 | points |
| Bogey Free Round | 4 | points |

| 3+ Birdie Streak | | |
|---|---|---|
| (One per Round) | 3 points | |
| Finish 1^{st} | 15 | points |
| Finish 2^{nd} | 13 | points |
| Finish 3^{rd} | 11 | points |
| Finish 4^{th} | 10 | points |
| Finish 5^{th} | 9 | points |
| Finish 6^{th} | 8 | points |
| Finish 7^{th} | 7 | points |
| Finish 8^{th} | 6 | points |
| Finish 9^{th} | 5 | points |
| Finish 10^{th} | 4 | points |
| Finish 11^{th}-15^{th} | 3 | points |
| Finish 16^{th}-20^{th} | 2 | points |
| Finish 21^{st}-25^{th} | 1 | point |

In one example of implementing Equation (4), the golfer's five best scores in the golfer's six most recent games as determined according to Table 2 may be 76, 101, 79, 83, and 90, yielding an average score value V of approximately 85.8. Applying Equation (4), the golfer's base salary B is approximately $17,160 which, in one embodiment, is rounded to the nearest multiple of $100: $17,200.

At act 408, the athlete's second modifier O is determined according to Equation (3) in a substantially similar manner as discussed above with respect to the exemplary pitcher. For example, and continuing with the example of the golfer having a base salary B of $17,200, the highest-earning golfer in the golfers' league may be earning $19,000. Applying Equation (3), the golfer's second modifier O is approximately 1.105, which may be rounded to the nearest multiple of 0.05, 1.10. At act 410, the process 400 ends.

As discussed above with respect to act 406, a base salary may be determined for an athlete and compared, at act 408, to a salary of a highest-earning athlete. In other embodiments, values other than salaries may be used to compare athletes and execute Equation (3), at least because Equation (3) may yield a unitless value. For example, Equations (2) and (4) may be modified such that D is a performance metric value, which may be a unitless value, and such that B is an athlete's base performance metric. Similarly, Equation (3) may be modified such that E is a highest-performing athlete's performance metric. An output of process 400 is a multiplier 208.

Accordingly, values for the points multiplier 208 may be determined for athletes competing in sports in which the athlete's performance is contingent on the performance of opposing athletes, and for athletes competing in sports in which the athlete's performance is not directly contingent on the performance of opposing athletes. Determining values for the points multiplier 208 may vary between different sporting events, and may vary between different positions in the sporting events. Examples of determining values for the points multipliers 208 consistent with the process 400 are provided below for exemplary purposes only.

In one example, the process 400 is executed to determine a points multiplier for a baseball hitter. At act 402, the process 400 begins. At act 404, a first modifier is determined based on an expected performance of a pitcher for an opposing team against which the hitter is scheduled to play. In one example, the first modifier is determined based on Equation (5),

$$M = \frac{( B * 2 ) + ( W * 2 ) + ( H * 2 ) + ( S * 4 ) + ( R * 2.5 ) + ( U * 3 )}{G * A}$$

where M is the first modifier, B is a total number of bases allowed by the pitcher, W is a number of walks allowed by the hitter, H is a number of HBPs by the pitcher, S is a number of stolen bases allowed by the pitcher, R is a total number of runs allowed by the pitcher, U is a total number of RBIs allowed by the pitcher, G is a number of games played by the pitcher, and A is an average score of hitters in the league.

At act 406, Equation (2) is executed to determine a base salary B for the hitter. For example, where a dollar value D is $900, a modifier M is 1.10, and the hitter's average score V is 9.67, the base salary B is approximately $9,600. The hitter's average score V may be calculated based on the hitter's m (for example, 12) best scores out of the hitter's n (for example, 15) most recent games, where the hitter may score points according to the conditions listed in Table 3.

TABLE 3
Example of Hitter Points Values

| Scoring Condition | Points Granted | |
|---|---|---|
| Single | 2 | points |
| Double | 4 | points |
| Triple | 6 | points |
| Home Run | 8 | points |
| Walk | 2 | points |
| Hit by Pitch | 2 | points |
| Run Scored | 2.5 | points |
| Runs Batted In | 3 | points |
| Stolen Base | 4 | points |
| Sacrifice Hit | 1 | point |
| Sacrifice Fly | 1 | point |

At act 408, Equation (3) is executed to determine a second modifier for the hitter. Continuing with the foregoing example in which the hitter's base salary B is approximately $9,600, and in an example in which a highest-earning hitter earns $12,300, the hitter's second modifier is approximately 1.30. Accordingly, the hitter has a points multiplier 208 of approximately 1.30.

In an example of American football athletes, the process 400 is executed to determine a points multiplier for an athlete in any one of a quarterback, wide receiver, or tight end position. At act 402, the process 400 begins. At act 404, a first modifier is determined based on an expected performance of an opposing defense of a team against which the athlete is scheduled to play. In one example, the first modifier is calculated based on Equation (6),

$$M = \frac{( P * 0.04 ) + ( R * 0.1 ) + ( T * 4 ) + ( O * 6 ) + ( C * 0.5 ) - ( I * 1 )}{G * A}$$

where M is the first modifier, P is a total number of passing yards allowed by the opposing defense, R is a total number of rushing yards allowed by the opposing defense, T is a total number of touchdown passes allowed by the opposing defense, O is a total number of touchdown rushes allowed by the opposing defense, C is a total number of completions allowed by the opposing defense, I is a total number of interceptions achieved by the opposing defense, G is a total number of games played by the opposing defense, and A is an average score for quarterbacks, wide receivers, and tight ends in the American football league.

At act 406, Equation (2) is executed to determine a base salary B for the athlete. For example, where a dollar value D is $800, a modifier M is 0.91, and the athlete's average score V is 25.43, the base salary B is approximately $21,600. The athlete's average score V may be calculated based on the athlete's m (for example, seven) best scores out of the athlete's n (for example, eight) most recent games, where the athlete may score points according to the conditions listed in Table 4.

TABLE 4
Example of American Football Points Values

| Scoring Condition | Points Granted | |
|---|---|---|
| Rushing Yard | 0.1 | points |
| Rushing Touchdown | 6 | points |
| Passing Yard | 0.04 | points |
| Passing Touchdown | 4 | points |
| Interception | −1 | point |
| Receiving Yard | 0.1 | points |
| Receiving Touchdown | 6 | points |
| Reception | 0.5 | points |
| Kickoff Return Touchdown | 6 | points |
| Punt Return Touchdown | 6 | points |
| Fumble Lost | −2 | points |
| Own-Fumble-Recovered | 6 | points |
| Touchdown | | |
| Two-Point Conversion | 2 | points |
| Received | | |
| Two-Point Conversion Pass | 2 | points |
| Extra-Point Conversion | 1 | point |
| 100+ Yards Rushing in | 2 | points |
| Game | | |
| 100+ Yards Receiving in | 2 | points |
| Game | | |
| 300+ Yards Passing in | 2 | points |
| Game | | |

At act 408, Equation (3) is executed to determine a second modifier for the athlete. Continuing with the foregoing example in which the athlete's base salary B is approximately $21,600, and in an example in which a highest-earning player playing in the same position as the athlete earns $23,000, the athlete's second modifier is approximately 1.05. Accordingly, the athlete has a points multiplier 208 of approximately 1.05.

In another example, the process 400 is executed to determine a points multiplier for an American football running back. Executing the process 400 in connection with a running back is substantially similar to executing the process 400 in connection with a wide receiver, quarterback, or tight end, with the exception of act 404.

At act 404, a first modifier is determined based on an expected performance of an opposing defense of a team against which the running back is scheduled to play. In one example, the first modifier is calculated based on Equation (7),

$$M = \frac{( Y * 0. 1 ) + ( T * 6 ) - ( F * 2 )}{G * A}$$

wherein M is the first modifier, Y is a total number of rushing yards allowed by the opposing defense, T is a total number of rushing touchdowns allowed by the opposing defense, F is a total number of fumbles recovered by the opposing defense, G is a total number of games played by the opposing defense, and A is an average score for running backs in the American football league. Acts 406-410 are executed similarly to the example provided above with respect to wide receivers, quarterbacks, and tight ends.

In an example of basketball athletes, the process 400 is executed to determine a points multiplier for an athlete in one of a guard and forward position. At act 402, the process 400 begins. At act 404, a first modifier is determined based on an expected performance of a defense of an opposing team against which the athlete is scheduled to play. In one example, the first modifier is calculated based Equation (8),

$$M = \frac{\begin{matrix}( P * 0.5 ) + ( T * 0.5 ) + ( R * 0.6 ) + ( I * 0. 8 ) + \\ ( S * 1.5 ) + ( B * 1.5 ) - ( T * 1 )\end{matrix}}{G * A}$$

where M is the first modifier, P is a total number of points allowed by the defense, T is a total number of three-point makes allowed by the defense, R is a total number of rebounds allowed by the defense, I is a total number of assists allowed by the defense, S is a total number of steals allowed by the defense, B is a total number of blocks allowed by the defense, T is a total number of turnovers forced by the defense, G is a total number of games played by the defense, and A is an average score for guards and forwards in the basketball league.

At act 406, Equation (2) is executed to determine a base salary B for the athlete. For example, where a dollar value D is $667, a modifier M is 0.95, and the athlete's average score V is 25.66, the base salary B is approximately $16,300. The athlete's average score V may be calculated based on the athlete's m (for example, eight) best scores out of the athlete's n (for example, 10) most recent games, where the athlete may score points according to the conditions listed in Table 5.

TABLE 5
Example of Basketball Points Values

| Scoring Condition | Points Granted | |
|---|---|---|
| Point Scored | 0.5 | points |
| Assist | 0.8 | points |
| Rebounds | 0.6 | points |
| Steal | 1.5 | points |
| Block | 1.5 | points |
| Turnover | −0.5 | points |
| 3-Point Shot Made | 0.5 | points |
| Double-Double | 1.5 | points |
| Triple-Double | 3 | points |

At act 408, Equation (3) is executed to determine a second modifier for the athlete. Continuing with the foregoing example in which the athlete's base salary B is approximately $16,300, and in an example in which a highest-earning player playing in the same position as the athlete earns $18,000, the athlete's second modifier is approximately 1.10. Accordingly, the athlete has a points multiplier 208 of approximately 1.10.

In an example of hockey athletes, the process 400 is executed to determine a points multiplier for an athlete in one of a center, forward, and defense position. At act 402, the process 400 begins. At act 404, a first modifier is determined based on an expected performance of a defense of an opposing team against which the athlete is scheduled to play. In one example, the first modifier may be calculated based on Equation (9),

$$M = \frac{( O * 6 ) + ( S * 4 ) + ( H * 0.25 )}{G * A}$$

wherein M is the first modifier, O is a number of goals allowed by the defense, S is a number of assists allowed by the defense, H is a number of shots allowed by the defense, G is a total number of games played by the defense, and A is an average score for centers, forwards, and defensemen in the hockey league.

At act 406, Equation (2) is executed to determine a base salary B for the athlete. For example, where a dollar value D is $1,500, a modifier M is 0.94, and the athlete's average score V is 11.17, the base salary B is approximately $15,800. The athlete's average score V may be calculated based on the athlete's m (for example, eight) best scores out of the athlete's n (for example, 10) most recent games, where the athlete may score points according to the conditions listed in Table 6.

TABLE 6
Example of Hockey Center, Forward, and Defense Points Values

| Scoring Condition | Points Granted | |
|---|---|---|
| Goal | 6 | points |
| Assist | 3 | points |
| Shot on Goal | 0.25 | points |
| Blocked Shot | 1 | point |
| Hit | 1 | point |
| Face-Off Won | 0.2 | points |
| Short-Handed Goal | 1 | point |
| Short-Handed Assist | 1 | point |

At act 408, Equation (3) is executed to determine a second modifier for the athlete. Continuing with the foregoing example in which the athlete's base salary B is approximately $15,800, and in an example in which the athlete is the highest-earning athlete in the athlete's position, the athlete's second modifier is 1.0. Accordingly, the athlete has a points multiplier 208 of 1.0.

In another example, the process 400 is executed to determine a points multiplier for a hockey goalie. At act 404, a first modifier is determined based on an expected performance of an offense of an opposing team against which the goalie is scheduled to play. In one example, the first modifier is calculated based on Equation (10),

$$M = \frac{( L * 6 ) + ( O * 6 ) - ( X * 2 ) + ( S * 0.4 )}{G * A}$$

where M is the first modifier, L is a total number of losses by the opposing team, O is a total number of overtime losses by the opposing team, X is a total number of goals by the opposing team, S is a total number of shots by the opposing team, G is a total number of games played by the offense, and A is an average score for goalies in the league.

At act 406, Equation (2) is executed to determine a base salary B for the athlete. For example, where a dollar value D is $1,500, a modifier M is 1.12, and the athlete's average score V is 10.56, the base salary B is approximately $17,700. The athlete's average score V may be calculated based on the athlete's m (for example, five) best scores out of the athlete's n (for example, six) most recent games, where the athlete may score points according to the conditions listed in Table 7.

TABLE 7
Example of Hockey Goalie Points Values

| Scoring Condition | Points Granted | |
|---|---|---|
| Win | 6 | points |
| Goal Against | −2 | points |
| Save | 0.4 | points |
| Shut Out | 4 | points |

At act 408, Equation (3) is executed to determine a second modifier for the athlete. Continuing with the foregoing example in which the athlete's base salary B is approximately $17,700, and in an example in which a highest-earning goalie earns $22,000, the athlete's second modifier is approximately 1.25. Accordingly, the athlete has a points multiplier 208 of approximately 1.25.

In certain examples, an athlete's base salary B may be limited within certain bounds. For example, the athlete's base salary B may be limited between a lower and upper bound defined by dollar values. If Equation (2) yields a base salary B that is higher than the upper bound, then the base salary B may be limited to the value of the upper bound. If Equation (2) yields a base salary B that is lower than the lower bound, then the base salary B may be limited to the value of the lower bound. In other examples, the athlete's base salary B is not limited by any bounds.

In some examples, an athlete's average score V may be calculated based on the athlete's n best scores out of the athlete's m most recent games, where n is greater than or equal to m. In some examples, n may exceed a number of games that have been played in a current season. Accordingly, scores from the most recent games in an immediately preceding season may be analyzed to account for a deficit between a number of games in a current season and n.

In this example, therefore, where a is a number of games played in a current season, a is less than n, and a+b=n, the athlete's scores from the b most recent games in which the athlete played in the previous season are analyzed to determine the athlete's average score V. For example, if, in determining an athlete's average score V, n is eight, and a is five, then the three most recent games in which the athlete played in an immediately preceding season are analyzed to determine the athlete's average score V.

In some examples, the athlete may not have played n games in the athlete's career in a league in which the athlete plays. The athlete's average score V may be determined based on an average of all of the games that the athlete has played. For example, where n is eight but the athlete has only ever played in three games, the athlete's average score V may be determined as the average of the three games in which the athlete has played.

As discussed above with respect to act 404, determining a first modifier for an athlete may be based on historical data pertaining to an opposing team. For example, in determining a first modifier for a pitcher based on an opposing team's hitters, the first modifier may be correlated to a number of strikeouts by the opposing team's hitters across a number of previous games. In some examples, the number of previous games may be variable or fixed. For example, where the number of previous games is variable, the number of previous games may be the total number of games played by in a current season. In another example, where the number of previous games is fixed, the number of previous games may be any positive value.

In some examples in which the number of previous games is fixed, the number may be less than the number of games played by the opposing team in a current season. In some examples, data used to calculate the first modifier may be gathered from a number of games in a previous season equal to the difference between the fixed value and the number of games played in the current season. In other examples, the first modifier may be calculated based only on data from the current season, despite the number of games played being less than the fixed number.

The rewards feature 104 will now be discussed in greater detail. Users of the application may receive rewards for using the application. For example, rewards may include tickets to sporting events, jerseys, signed merchandise, and so forth. In another example, rewards may include digital currency which may be used to purchase digital or physical items in the application.

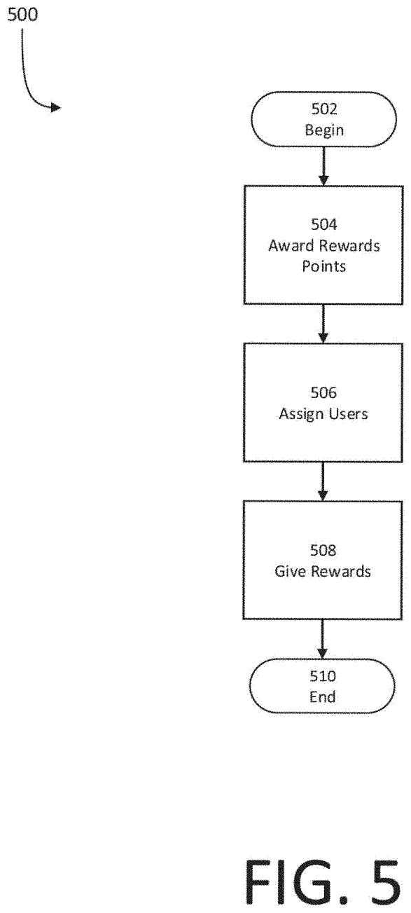

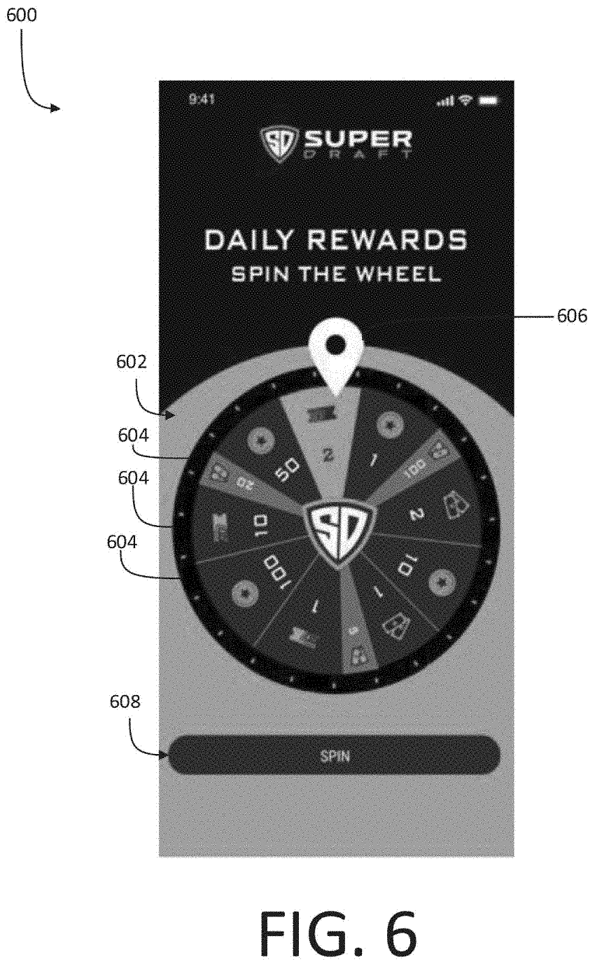

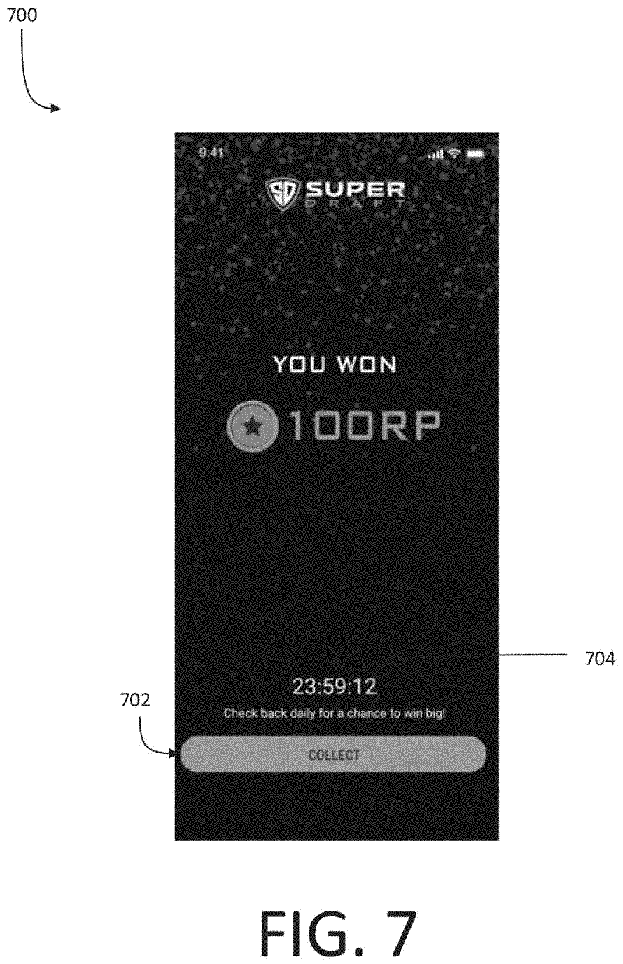

FIG. 5 illustrates a process 500 of earning rewards. The process 500 may be executed by the fantasy sports application. At act 502, the process 500 begins. At act 504, reward points are awarded to a user. For example, reward points may be awarded to a user based on the user's performance in a fantasy sports match. Generally speaking, the number of reward points awarded to a user may be positively correlated to the user's performance in the match. In another example, discussed in greater detail below with respect to FIGS. 6 and 7, reward points may be awarded to users based on in-application games.

At act 506, users are assigned to tiers based on a number of reward points collected by the users. Tiers may be associated with a range of reward points values, and users having reward points values within a respective range may be assigned to a corresponding tier. Generally speaking, higher tiers are associated with higher numbers of reward points. Users may be assigned to tiers on a periodic basis based on a number of rewards points collected by respective users in a period of time. For example, where a period of time is one month, users may be assigned to tiers on the first day of each month based on a number of rewards points collected in a previous month.

At act 508, users are given rewards. A number and quality of rewards may be based on a tier in which the user is placed. For example, a user in a low tier may be guaranteed to receive a low-quality reward, with a small chance to receive a medium-quality reward. Conversely, a user in a higher tier may be guaranteed to receive several low-quality rewards and several medium-quality rewards, with a moderate chance of receiving a high-quality reward. Thus, the rewards received by a user are generally correlated to a number of reward points accumulated by the user. At act 510, the process 500 ends.

As discussed above with respect to act 504, reward points may be awarded through games offered by the application. For example, a game may include a spinner wheel game. Users can activate a digital spinner wheel, which ultimately selects a reward which is awarded to the user. After activating the digital spinner wheel, the user may be unable to activate the digital spinner wheel until an amount of time has elapsed (for example, one hour, 12 hours, 24 hours, one week, and so forth).

FIG. 6 illustrates a view 600 of an example daily spinner wheel game. The game includes a spinner wheel 602 having rewards 604 illustrated thereon. The spinner wheel 602 includes a pointer 606 which points at one of the rewards 604. The game also includes a spin button 608 which, when activated, spins the spinner wheel 602. When the spinner wheel 602 subsequently comes to a stop, a reward pointed to by the pointer 606 is awarded to the user. For example, if the spinner wheel 602 stops and the pointer 606 is pointing to one of the rewards 604 that illustrates 100 Rewards Points (RP), then the user is awarded 100 RP.

FIG. 7 illustrates a view 700 of an example rewards screen after the spinner wheel 602 stops with the pointer 606 pointing at the 100 RP reward. A user collects the 100 RP reward by activating a collect button 702. The view 700 also provides a cooldown display 704 indicating an amount of time that must elapse until the user is allowed to activate the spinner wheel 602 again.

As discussed above with respect to act 506, users are assigned to tiers based on a number of reward points collected by the users. For example, Table 8 illustrates several tiers, and a corresponding number of reward points that must be acquired to be placed in each tier.

TABLE 8
Example of Rewards Tiers

| Tier | Reward Point Range | |
|---|---|---|
| White | 1-99 | RP |
| Bronze | 100-499 | RP |
| Silver | 500-1,999 | RP |
| Gold | 2,000-9,999 | RP |
| Platinum | 10,000-24,999 | RP |
| Diamond | 25,000-124,999 | RP |
| Black | 125,000+ | RP |

Accordingly, in an embodiment in which Table 8 is implemented, a user having 50 RP will be placed in the white tier, a user having 300 RP will be placed in the bronze tier, a user having 500 RP will be placed in the silver tier, and so forth. In other embodiments, a number of tiers may be greater or fewer than the number of tiers illustrated in Table 8. Furthermore, in other embodiments, tiers may be associated with any other range of RP.

The rivalry feature 106 will now be discussed in greater detail. Generally speaking, the rivalry feature 106 includes determining rivals for a user, and providing information about the user's rivals.

Determining rivals for a first user may include determining a number (for example, three, five, 10, and so forth) of users against whom the first user competes most frequently. For example, determining rivals for a first user may include determining five other users against whom the first user has competed against must frequently, in terms of time played or in terms of a number of games played. Rivals may be specific to each sporting event, or may be determined globally across all sporting events.

Rivals may be ranked according to a rival score computed with respect to each of a user's rivals. Rival scores may be based on head-to-head contests between the user and the respective rival. Rival scores may have a weighted average based on a sport in which the user is competing against the rival. Sports may be assigned weights based on how frequently contests are available for the corresponding sports. For example, football contests may be given a higher weight than baseball contests, because baseball events usually occur more frequently than football contests. Thus, a user may not be more likely to have a baseball rival than a football rival simply because the user has engaged in more contests against the baseball rival.

Providing information about the first user's rivals may include, for example, providing information about one or more of a total number of games played against a rival, a win-loss record against each rival, a margin of victory against each rival, a streak (for example, a winning or losing streak) against each rival, and so forth. Furthermore, by providing information about the first user's rivals, the first user may easily keep track of rivals and challenge the rivals.

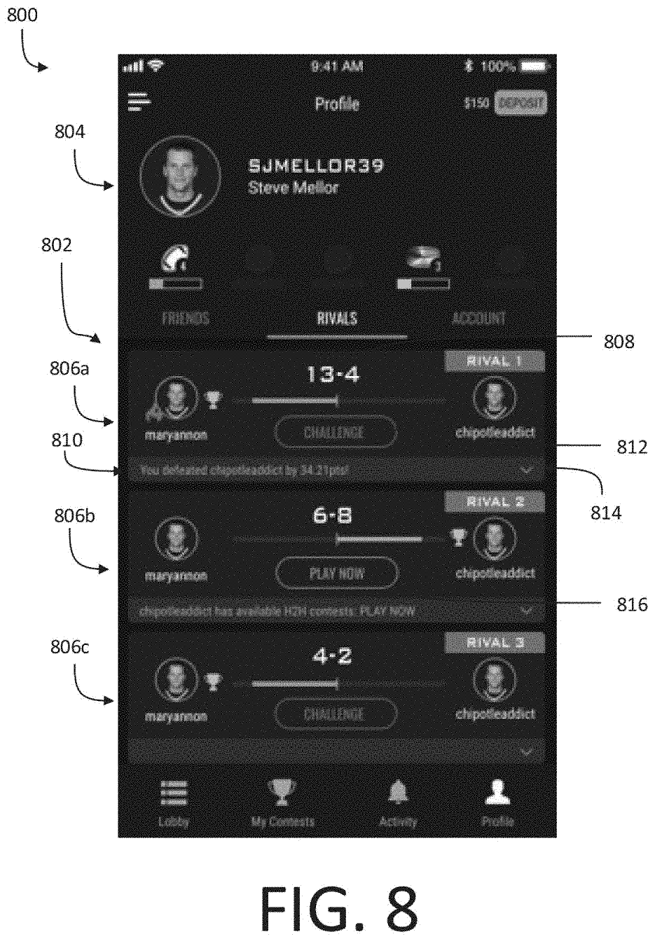

FIG. 8 illustrates a view 800 of an example of the rivalry feature 106. The view 800 illustrates rivalry information 802 for a first user 804. The rivalry information 802 includes rival profiles 806 for three of the first user's 804 rivals. For example, a rival profile 806a for a first rival includes win-loss record information 808 between the first user 804 and the first rival, recap information 810, and a challenge button 812.

The win-loss record information 808 indicates a number of wins and losses against the first rival, and may be specific to one sporting event or may globally include all sporting events. The recap information 810 indicates information pertaining to a most recent game against the first rival including, for example, a margin by which the first rival won or lost. Additional recap information may be displayed by activating a recap information expansion button 814. The challenge button 812 enables the first user 804 to challenge the first rival to compete in a game responsive to activation of the challenge button 812. For example, challenging the first rival may transmit a notification to the first rival indicating that the first user 804 desires to compete against the first rival. The first rival may subsequently accept the challenge, and a competition may be initiated between the first rival and the first user 804.

Each of rival profile 806b, which corresponds to a second rival, and rival profile 806c, which corresponds to a third rival, is substantially similar to the rival profile 806a. However, the rival profile 806b differs from the rival profile 806a at least in that the rival profile 806b has a play now button 816 rather than the challenge button 812. The play now button 816 enables the first user 804 to automatically initiate a competition with the second rival rather than requesting that the second rival compete with the first user 804. For example, the play now button 816 may be available to the first user 804 where the second rival has challenged the first user 804 to a competition.

The squads feature 108 will now be discussed in greater detail. As discussed above, the squads feature 108 enables users to form squads, or groups of users. Squads may subsequently compete against other squads in head-to-head competitions. Squads may also compete in tournament-style competitions. Squad members may receive rewards based on their performance, such as RP, merchandise, or other rewards.

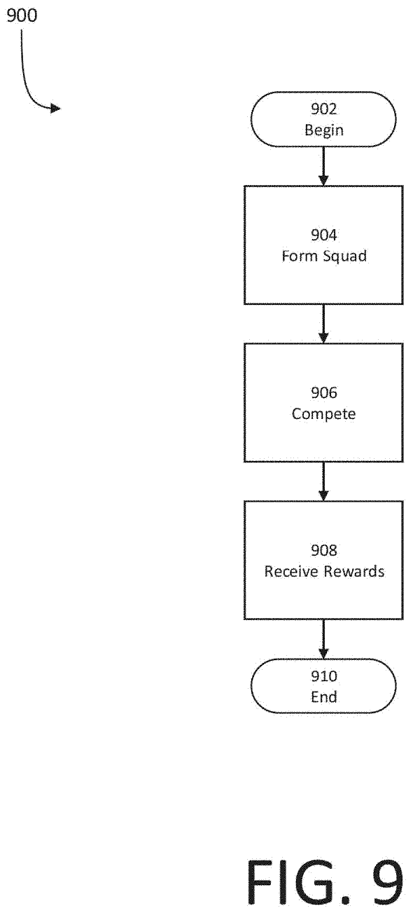

FIG. 9 illustrates a process 900 of executing squad-based competitions. The process 900 may be executed by the fantasy sports application. At act 902, the process 900 begins. At act 904, a squad is formed. A user may form a squad by selecting squad details, and inviting other users to join the squad. Squad details may include a team name, logo, identity, and so forth. The user that creates the squad is referred to as a “team captain,” and controls aspects of the squad, including how many users may be in the squad and which competitions the squad competes in.

At act 906, the squad competes against other squads. Competing against other squads may include competing against a squad having an identical number of users. For example, a first squad having two users may compete against a second squad having two users. Competitions between squads generally includes drafting, by each player on each fantasy team, a respective team of players. Drafted players accumulate points for the fantasy teams to which they are drafted. The points accumulated by each fantasy team of each player on a squad are then aggregated and compared to an aggregate score of an opposing squad. A squad having a higher aggregate score in a competition wins the competition.

For example, and continuing with an example in which a first squad of two players competes against a second squad of two players, each player drafts a fantasy team. Thus, a first player on the first squad drafts a first fantasy team, and a second player on the first squad drafts a second fantasy team independently of the first fantasy team. A similar process is performed by the second squad. As the competition begins, each fantasy team accumulates points based on the drafted players' performance. For example, the first fantasy team may score 100 points, and the second fantasy team may score 150 points. The first squad thus has an aggregate score of 250 points. If the aggregate score of the second squad is less than 250, then the first squad wins. If the aggregate score of the second squad is greater than 250, then the second squad wins. If the aggregate score of the second squad is exactly 250, then a draw may be declared.

At act 908, the squad receives rewards. Rewards may be based on the squad's performance. For example, if the squad wins a competition, the squad may receive more rewards than if the squad had lost the competition. Furthermore, if the squad wins the competition by a large margin, the squad may receive more rewards than if the squad had won the competition by a smaller margin. Squads may also receive rewards based on a number of points accumulated based on the squad's teams' performance, regardless of whether the squad won the competition. In other embodiments, rewards may be correlated to other performance metrics. At act 910, the process 900 ends.

In some examples, a tournament-style competition may be provided between squads. For example, a season for a sporting event may be broken into a regular season and a playoff season. During the regular season, squads compete as discussed above with respect to the process 900. Based on the squads' performance across all or some of the sporting events during the regular season, the squads are placed into ranked divisions. In one example, squads are placed into one of nine ranked divisions. At the end of the regular season, a number of highest-performing squads in each division may be selected to compete in a playoff tournament against each other.

For example, the five highest-performing squads in each division may be selected for playoff tournaments, with one tournament per division. In examples in which squads are placed into nine ranked divisions, nine tournaments are conducted. Each tournament of the nine tournaments may be conducted between the five highest-performing squads in a corresponding division. Tournaments may be conducted in a knockout-style format in which, after each head-to-head competition between two opposing squads, a losing squad is eliminated. Thus, the tournament continues until a single, winning squad remains. The winning squad may receive rewards, and may be advanced to a higher division.

The prediction feature 110 will now be discussed in greater detail. As discussed above, the prediction feature 110 enables users to predict an outcome of an event before the event occurs in real-time. Users are rewarded for correctly predicting an outcome of an event. Rewards may be correlated to the complexity or specificity of the prediction such that harder-to-predict events are better-compensated than easier-to-predict events.

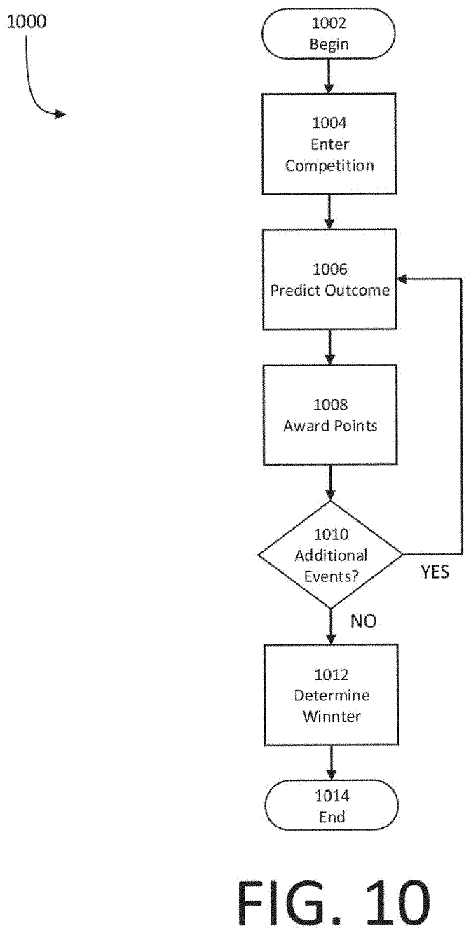

FIG. 10 illustrates a process 1000 of executing a prediction feature. The process 1000 may be executed by the fantasy sports application. At act 1002, the process 1000 begins. At act 1004, a user enters a prediction competition. Entering a prediction competition may include selecting an open competition hosted by one or more users. A host of the prediction competition specifies various terms including, for example, a length of the competition (for example, a number of baseball innings), a type of competition, the stakes of the competition, and a time at which the competition will start. In some examples, once the competition starts, additional users will be unable to join the competition.

At act 1006, users predict an outcome of an event. Events may differ between sporting events. For example, an event in a baseball sporting event may be a hitter going to bat. Predictions may include, for example, that the hitter will strike out, that the hitter will hit a home run, and so forth. In some examples, predictions will not be allowed after a certain time. For example, and continuing with the foregoing example, a user predicting the result of a hitter going to bat may be required to submit a prediction before the hitter transitions from being on deck to going to bat. In some examples, users are required to select at most one prediction, and predictions will be kept secret from other users while users are still able to change their predictions.

At act 1008, points are awarded to users based on the outcome of the event for which a prediction was made at act 1006. If the user correctly predicted the outcome of the event, then the user is awarded points which are counted towards a total points value accumulated over the duration of the prediction competition set by the competition host. Otherwise, the user may either receive no points or lose points. Generally speaking, a number of points awarded to a user for a correct prediction is determined based on the specificity of the event. For example, a first user that predicts that a hitter will obtain a hit may obtain fewer points than a second user that predicts that the hitter will hit a double, because the second user's prediction is more specific and thus less likely.

At act 1010, a determination is made as to whether additional events remain in the prediction competition. If additional events remain in the prediction competition (1010 YES), then the process 1000 returns to act 1006. Otherwise, if there are no remaining events in the prediction competition (1010 NO), then the process 1000 continues to act 1012. At act 1012, a winner of the prediction competition is determined. For example, a winner of the prediction competition may be a user in the prediction competition who has a highest total points value. As discussed above, a user's total points valued is an aggregation of points accumulated by correctly predicting events in the prediction competition. The winner of the prediction competition receives rewards, which may be specified by the host of the prediction competition. At act 1014, the process 1000 ends.

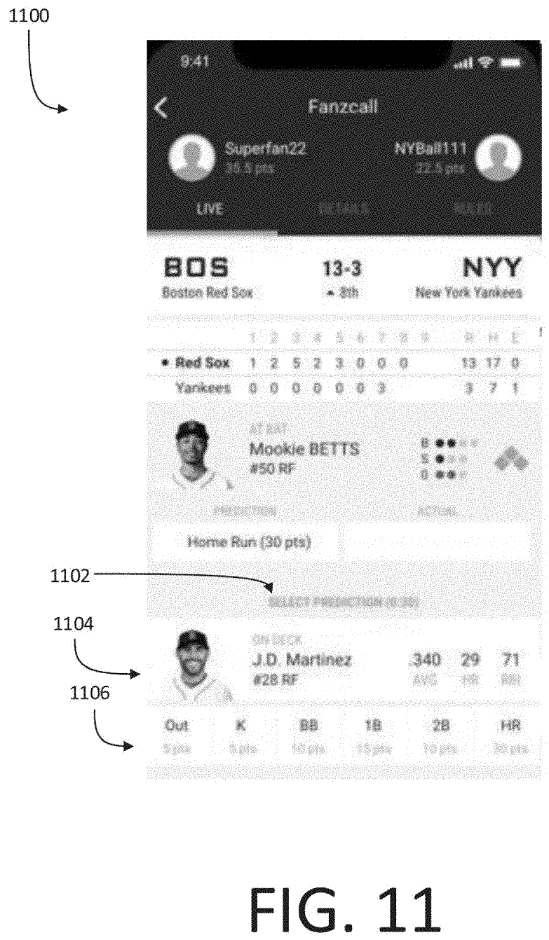

FIG. 11 illustrates a view 1100 of an example of the prediction feature 110. The view 1100 includes a countdown timer 1102 indicating an amount of time until the user must submit a prediction, at which point a user's selection cannot be changed, and a prediction selection display 1104. The prediction selection display 1104 includes details of a baseball hitter that is about to play, and prediction selection buttons 1106. Each of the prediction selection buttons 1106 corresponds to a different event prediction outcome, and indicates a number of points that will be awarded if the prediction is correctly selected. For example, event prediction outcomes may include the hitter striking out, hitting a base hit, hitting a home run, and so forth.

In some examples, users may be prompted with prediction questions at the beginning of larger-scale events. A larger-scale event may include an entire baseball game or inning, whereas examples of events predicted at act 1006 may include each individual at-bat. For example, before an inning begins, users may be asked to predict how many pitches will be thrown in the inning, or how many runs will be scored in the inning. Points may be subsequently awarded to players based on a successful prediction, such as by correctly predicting an answer to the question or by predicting a closest answer to the question.

Prediction competitions may include two or more users. In some examples, only a highest-scoring user in the prediction competition receives rewards. In other examples, several of the highest-scoring users in the prediction competition receive rewards. For example, in a competition of eight users, the top three highest-scoring users may receive rewards based on their performance. Each of the highest-scoring users may receive the same rewards, or different rewards. For example, a highest-scoring user may receive the best rewards, a second-highest-scoring user may receive a second-best reward, and so forth.

In certain examples, hosts of prediction competitions may set any parameters for the competition. For example, a host may be unrestricted in setting a buy-in cost and winning reward, and hosts may be able to specify any length of time for the prediction competition to last. In other embodiments, hosts may be able to select competition parameters within certain limits. For example, a length of a prediction competition may be disallowed from being lower than a certain minimum time. In the context of baseball, for example, a host may be disallowed from selecting a competition duration that is less than one inning, such that both baseball teams are allowed to have a scoring opportunity. In another example, in the context of American football, a host may be disallowed from selecting a competition duration that is less than one quarter. In other examples, other minimum or maximum durations may be imposed on hosts.

The ranking feature 112 will now be discussed in greater detail. As discussed above, the ranking feature 112 provides users with sporting event-specific rankings based on their performance. Users may be divided into ranks, which may be further divided into sub-ranks. As users compete in sporting event competitions, the users accumulate points which enable users to advance through ranks. For example, a user may start at rank one, sub-rank one, in a baseball category. As the user competes in baseball competitions, the user receives points. Once the user has accumulated enough points, the user may advance to rank one, sub-rank two. Each rank and sub-rank may require the user to attain a specific number of points before attaining the corresponding rank and sub-rank. As the user advances through ranks, the number of points required to advance to a higher rank may increase.

Each time a user advances to another rank or sub-rank, the user may receive rewards, such as RP. Rewards may increase in quality as the user advances further. For example, a reward for advancing to rank one, sub-rank two may be worse than a reward for advancing to rank two, sub-rank two. Furthermore, any number of ranks and sub-ranks may be implemented. For example, in one embodiment, there may be nine ranks and nine sub-ranks per rank. In another example, there may be nine ranks and zero sub-ranks. In other examples, any other number of ranks and sub-ranks may be implemented.

In some embodiments, ranks may be specific to each sporting event, and may be independent of other sporting events. Therefore, to advance through ranks in a baseball ranking, the user may be required to compete in baseball competitions. Thus, a user may be ranked at rank one, sub-rank one in American football, but may be ranked at rank five, sub-rank three in baseball.

Embodiments of a fantasy sports application has been described. Embodiments of the fantasy sports application may include one or more of the features 100. As discussed above, the fantasy sports application may be executed by an electronic device including, for example, a mobile phone, a tablet computer, a personal computer, and so forth. Using data stored in associated memory, the electronic device may execute one or more instructions stored on one or more non-transitory computer-readable media that may result in manipulated data to execute the functionality described above. For example, the electronic device may execute one or more stored instructions to execute one or more of the processes 300, 400, 500, 900, and 1000.

In some examples, the electronic device may include one or more processors or other types of controllers. In another example, the electronic device includes a Field-Programmable Gate Array (FPGA) controller. In yet another example, the electronic device performs a portion of the functions disclosed herein on a processor and performs another portion using an Application-Specific Integrated Circuit (ASIC) tailored to perform particular operations. As illustrated by these examples, examples in accordance with the present disclosure may perform the operations described herein using many specific combinations of hardware and software and the disclosure is not limited to any particular combination of hardware and software components.

The electronic device may further include one or more inputs and outputs. For example, the electronic device may include an input configured to receive inputs from a user, such as a touch-sensitive screen. In another example, the electronic device may include a display to provide an output to a user. For example, the electronic device may include a display screen configured to display one or more of the views 200, 600, 700, 800, and 1100.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A method of providing a fantasy sports application, the method comprising:
determining, for a first athlete, a first modifier based on an expected performance of the first athlete;
determining, for the first athlete, a raw score value based on a performance of the first athlete in a sporting event;
determining, for the first athlete, a modified score value based on the first modifier and based on the raw score value; and
awarding the modified score value to at least one user of the fantasy sports application.

2. The method of claim 1, wherein awarding the modified score value to the at least one user is executed subsequent to the at least one user drafting the first athlete to a first fantasy team of the at least one user.

3. The method of claim 1, wherein determining the first modifier includes:
determining, for the first athlete, a first performance metric based on a past performance of the first athlete; and
determining, for the first athlete, the first modifier based on the first performance metric and based on a second performance metric of a highest-performing athlete.

4. The method of claim 3, wherein determining the first modifier is based on a position played by the first athlete, and wherein the highest-performing athlete is a highest-performing athlete in the position.

5. The method of claim 4, wherein determining the modified score value includes multiplying the first modifier by the raw score value.

6. The method of claim 5, wherein determining the first modifier further includes determining, for the first athlete, a second modifier based on an expected future performance of the first athlete, and wherein determining the first performance metric is further based on the second modifier.

7. The method of claim 6, wherein determining the second modifier includes determining an expected performance of a team against which the first athlete is scheduled to play.

8. The method of claim 7, wherein the expected performance of the team is based on a past performance of the team.

9. The method of claim 5, wherein the first modifier is a ratio of the second performance metric to the first performance metric.

10. The method of claim 3, wherein the first performance metric is based on an average score value of the first athlete in at least one previous game.

11. A non-transitory computer-readable medium storing sequences of computer-executable instructions for providing a fantasy sports application, the sequences of computer-executable instructions including instructions that instruct at least one processor to:
determine, for a first athlete, a first modifier based on an expected performance of the first athlete;
determine, for the first athlete, a raw score value based on a performance of the first athlete in a sporting event;
determine, for the first athlete, a modified score value based on the first modifier and based on the raw score value; and
award the modified score value to at least one user of the fantasy sports application.

12. The non-transitory computer-readable medium of claim 11, wherein awarding the modified score value to the at least one user is executed subsequent to the at least one user drafting the first athlete to a first fantasy team of the at least one user.

13. The non-transitory computer-readable medium of claim 11, wherein in determining the first modifier, the at least one processor executes instructions to:
determine, for the first athlete, a first performance metric based on a past performance of the first athlete; and
determine, for the first athlete, the first modifier based on the first performance metric and based on a second performance metric of a highest-performing athlete.

14. The non-transitory computer-readable medium of claim 13, wherein determining the first modifier is based on a position played by the first athlete, and wherein the highest-performing athlete is a highest-performing athlete in the position.

15. The non-transitory computer-readable medium of claim 14, wherein in determining the modified score value, the at least one processor executes instructions to multiply the first modifier by the raw score value.

16. The non-transitory computer-readable medium of claim 15, wherein in determining the first modifier, the at least one processor executes instructions to determine, for the first athlete, a second modifier based on an expected future performance of the first athlete, and wherein determining the first performance metric is further based on the second modifier.

17. The non-transitory computer-readable medium of claim 16, wherein in determining the second modifier, the at least one processor executes instructions to determine an expected performance of a team against which the first athlete is scheduled to play.

18. The non-transitory computer-readable medium of claim 17, wherein the expected performance of the team is based on a past performance of the team.

19. The non-transitory computer-readable medium of claim 15, wherein the first modifier is a ratio of the second performance metric to the first performance metric.

20. The non-transitory computer-readable medium of claim 13, wherein the first performance metric is based on an average score value of the first athlete in at least one previous game.
